(19) United States
(12) Patent Application Publication
(10) Pub. No.: US 2024/0114547 A1
(43) Pub. Date: Apr. 4, 2024

(54) UPLINK SUBBAND FOR INITIAL ACCESS

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Abdelrahman Mohamed Ahmed Mohamed IBRAHIM, San Diego, CA (US); Ahmed Attia ABOTABL, San Diego, CA (US); Gokul SRIDHARAN, Sunnyvale, CA (US); Hung Dinh LY, San Diego, CA (US)

(21) Appl. No.: 18/348,769

(22) Filed: Jul. 7, 2023

Related U.S. Application Data
(60) Provisional application No. 63/377,966, filed on Sep. 30, 2022.

(51) Int. Cl. H04W 74/00; H04L 5/14; H04W 74/08

(52) U.S. Cl. CPC H04W 74/004; H04L 5/14; H04W 74/0833

(57) ABSTRACT

Various aspects of the present disclosure generally relate to wireless communication. In some aspects, a user equipment (UE) may receive system information for performing an initial access procedure using an uplink subband of subband full-duplex symbols. The UE may transmit an initial access message in the uplink subband. Numerous other aspects are described.

### CROSS-REFERENCE TO RELATED APPLICATION

This patent application claims priority to U.S. Provisional Patent Application No. 63/377,966, filed on Sep. 30, 2022, entitled “UPLINK SUBBAND FOR RANDOM ACCESS,” and assigned to the assignee hereof. The disclosure of the prior application is considered part of and is incorporated by reference into this patent application.

### FIELD OF THE DISCLOSURE

Aspects of the present disclosure generally relate to wireless communication and specifically to techniques and apparatuses for using an uplink subband for initial access.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving system information for performing an initial access procedure (e.g., random access channel (RACH) procedure) using an uplink subband of subband full-duplex (SBFD) symbols. The method may include transmitting an initial access message in the uplink subband.

Some aspects described herein relate to a method of wireless communication performed by a network entity. The method may include transmitting system information for performing an initial access procedure using an uplink subband of subband full-duplex symbols. The method may include receiving an initial access message in the uplink subband.

Some aspects described herein relate to a UE for wireless communication. The UE may include one or more memories and one or more processors coupled to the one or more memories. The one or more processors may be individually or collectively configured to cause the UE to receive system information for performing an initial access procedure using an uplink subband of SBFD symbols. The one or more processors may be individually or collectively configured to cause the UE to transmit an initial access message in the uplink subband.

Some aspects described herein relate to a network entity for wireless communication. The network entity may include one or more memories and one or more processors coupled to the one or more memories. The one or more processors may be individually or collectively configured to cause the network entity to transmit system information for performing an initial access procedure using an uplink subband of subband full-duplex symbols. The one or more processors may be individually or collectively configured to cause the network entity to receive an initial access message in the uplink subband.

Some aspects described herein relate to a non-transitory computer-readable medium that stores a set of instructions for wireless communication by a UE. The set of instructions, when executed by one or more processors of the UE, may cause the UE to receive system information for performing an initial access procedure using an uplink subband of subband full-duplex symbols. The set of instructions, when executed by one or more processors of the UE, may cause the UE to transmit an initial access message in the uplink subband.

Some aspects described herein relate to a non-transitory computer-readable medium that stores a set of instructions for wireless communication by a network entity. The set of instructions, when executed by one or more processors of the network entity, may cause the network entity to transmit system information for performing an initial access procedure using an uplink subband of subband full-duplex symbols. The set of instructions, when executed by one or more processors of the network entity, may cause the network entity to receive an initial access message in the uplink subband.

Some aspects described herein relate to an apparatus for wireless communication. The apparatus may include means for receiving system information for performing an initial access procedure using an uplink subband of subband full-duplex symbols. The apparatus may include means for transmitting an initial access message in the uplink subband.

Some aspects described herein relate to an apparatus for wireless communication. The apparatus may include means for transmitting system information for performing an initial access procedure using an uplink subband of subband full-duplex symbols. The apparatus may include means for receiving an initial access message in the uplink subband.

Some aspects described herein relate to a method of wireless communication performed by a UE. The method may include receiving system information for an uplink subband (UL-SB) for initial access procedure (e.g., RACH procedure) messages in an SBFD configuration. The method may include transmitting an initial access message in the UL-SB.

Some aspects described herein relate to a method of wireless communication performed by a network entity. The method may include transmitting system information for an UL-SB for initial access procedure messages in a subband full-duplex configuration. The method may include receiving an initial access message in the UL-SB.

Some aspects described herein relate to a UE for wireless communication. The UE may include one or more memories and one or more processors coupled to the one or more memories. The one or more processors may be individually or collectively configured to cause the UE to receive system information for an UL-SB for initial access procedure messages in SBFD configuration. The one or more processors may be individually or collectively configured to cause the UE to transmit an initial access message in the UL-SB.

Some aspects described herein relate to a network entity for wireless communication. The network entity may include one or more memories and one or more processors coupled to the one or more memories. The one or more processors may be individually or collectively configured to cause the network entity to transmit system information for an UL-SB for initial access procedure messages in a subband full-duplex configuration. The one or more processors may be individually or collectively configured to cause the network entity to receive an initial access message in the UL-SB.

Some aspects described herein relate to a non-transitory computer-readable medium that stores a set of instructions for wireless communication by a UE. The set of instructions, when executed by one or more processors of the UE, may cause the UE to receive system information for an UL-SB for initial access procedure messages in SBFD configuration. The set of instructions, when executed by one or more processors of the UE, may cause the UE to transmit an initial access message in the UL-SB.

Some aspects described herein relate to a non-transitory computer-readable medium that stores a set of instructions for wireless communication by a network entity. The set of instructions, when executed by one or more processors of the network entity, may cause the network entity to transmit system information for an UL-SB for initial access procedure messages in a subband full-duplex configuration. The set of instructions, when executed by one or more processors of the network entity, may cause the network entity to receive an initial access message in the UL-SB.

Some aspects described herein relate to an apparatus for wireless communication. The apparatus may include means for receiving system information for an UL-SB for initial access procedure messages in SBFD configuration. The apparatus may include means for transmitting an initial access message in the UL-SB.

Some aspects described herein relate to an apparatus for wireless communication. The apparatus may include means for transmitting system information for an UL-SB for initial access procedure messages in a subband full-duplex configuration. The apparatus may include means for receiving an initial access message in the UL-SB.

Aspects generally include a method, apparatus, system, computer program product, non-transitory computer-readable medium, UE, base station, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example disaggregated base station architecture, in accordance with the present disclosure.

FIGS. 4A-4C are diagrams illustrating examples of full-duplex (FD) communication in accordance with the present disclosure.

FIG. 5 is a diagram illustrating an example of FD communication modes, in accordance with the present disclosure.

FIG. 6 is a diagram illustrating examples of FD communication, in accordance with the present disclosure.

FIG. 7 is a diagram illustrating an example of a slot pattern with subband FD (SBFD) slots, in accordance with the present disclosure.

FIG. 8 is a diagram illustrating examples of slot patterns for SBFD operation, in accordance with the present disclosure.

FIG. 9 is a diagram illustrating an example of an uplink subband (UL-SB), in accordance with the present disclosure.

FIG. 10 is a diagram of an example associated with using an UL-SB, in accordance with the present disclosure.

FIG. 11 is a diagram illustrating examples of uplink frequency resources, in accordance with the present disclosure.

FIG. 12 is a diagram illustrating examples of an initial uplink bandwidth part, in accordance with the present disclosure.

FIG. 13 is a diagram illustrating an example process performed, for example, by a UE, in accordance with the present disclosure.

FIG. 14 is a diagram illustrating an example process performed, for example, by a network entity, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

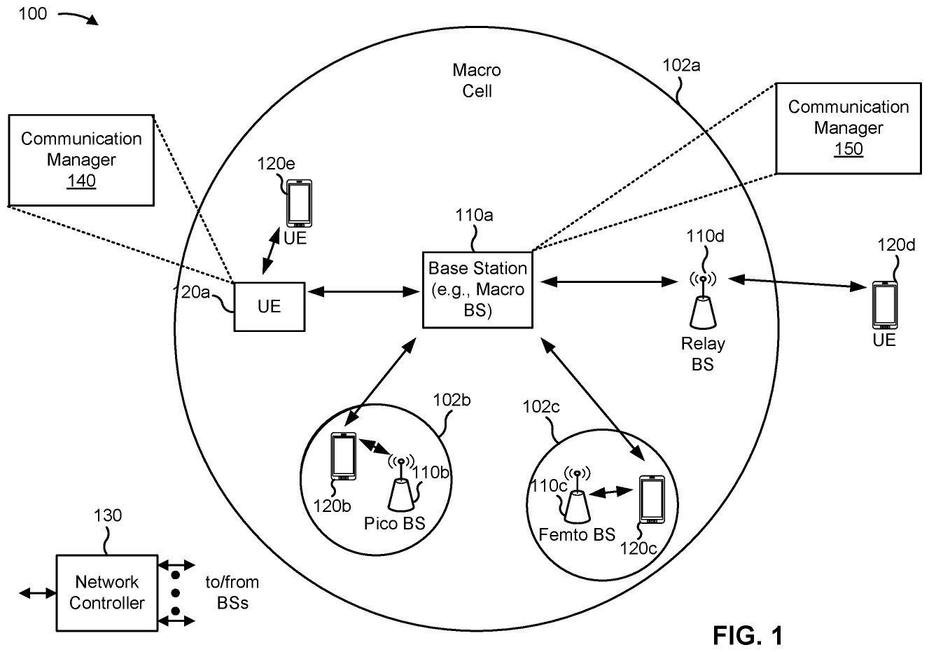

FIG. 1 is a diagram illustrating an example of a wireless network in accordance with the present disclosure. The wireless network 100 may be or may include elements of a 5G (e.g., NR) network or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some aspects, the terms “base station” (e.g., the base station 110) or “network entity” may refer to an aggregated base station, a disaggregated base station, an integrated access and backhaul (IAB) node, a relay node, or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the terms “base station” or “network entity” may refer to one device configured to perform one or more functions, such as those described herein in connection with the base station 110. In some aspects, the terms “base station” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network entity” may refer to any one or more of those different devices. In some aspects, the terms “base station” or “network entity” may refer to one or more virtual base stations or one or more virtual base station functions. For example, in some aspects, two or more base station functions may be instantiated on a single device. In some aspects, the terms “base station” or “network entity” may refer to one of the base station functions and not another. In this way, a single device may include more than one base station.

In some examples, a cell may not necessarily be stationary, and the geographic area of the cell may move in accordance with the location of a base station 110 that is mobile (e.g., a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (e.g., a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (e.g., one or more processors) and the memory components (e.g., a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz,” if used herein, may broadly represent frequencies that may be less than 6 GHz, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (e.g., FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive system information for an uplink subband (UL-SB) for initial access procedure (e.g., random access channel (RACH) procedure) messages in a subband full-duplex (SBFD) configuration. The communication manager 140 may transmit an initial access message in the UL-SB.

In some aspects, the communication manager 140 may receive system information for performing an initial access procedure using an uplink subband of SBFD symbols. The communication manager 140 may transmit an initial access message in the uplink subband. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit system information for an UL-SB for initial access procedure messages in an SBFD configuration. The communication manager 150 may receive an initial access message in the UL-SB.

In some aspects, the communication manager 150 may transmit system information for performing an initial access procedure using an uplink subband of subband full-duplex symbols. The communication manager 150 may receive an initial access message in the uplink subband. Additionally, or alternatively, the communication manager 150 may perform one or more other operations described herein.

As indicated above, FIG. 1 is provided as an example. Other examples may differ from what is described with regard to FIG. 1.

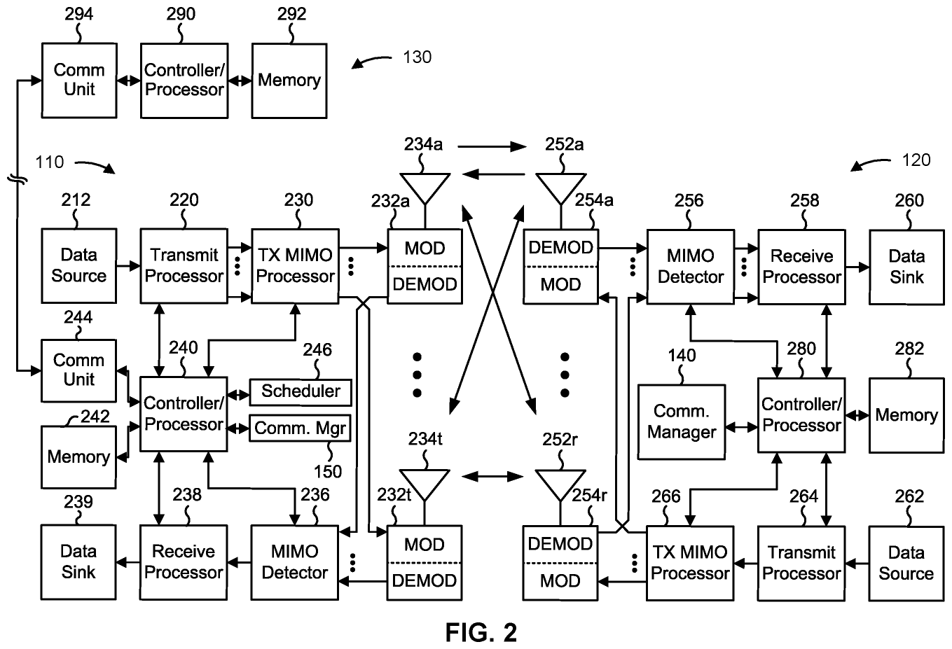

FIG. 2 is a diagram illustrating an example base station 110 in communication with a UE 120 in a wireless network in accordance with the present disclosure. The base station 110 may correspond to the base station 110 of FIG. 1. Similarly, the UE 120 may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (e.g., for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (e.g., the controller/processor 280) and the memory 282 to perform aspects of any of the methods described herein.

At the base station 110, the uplink signals from UE 120 or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (e.g., the controller/processor 240) and the memory 242 to perform aspects of any of the methods described herein.

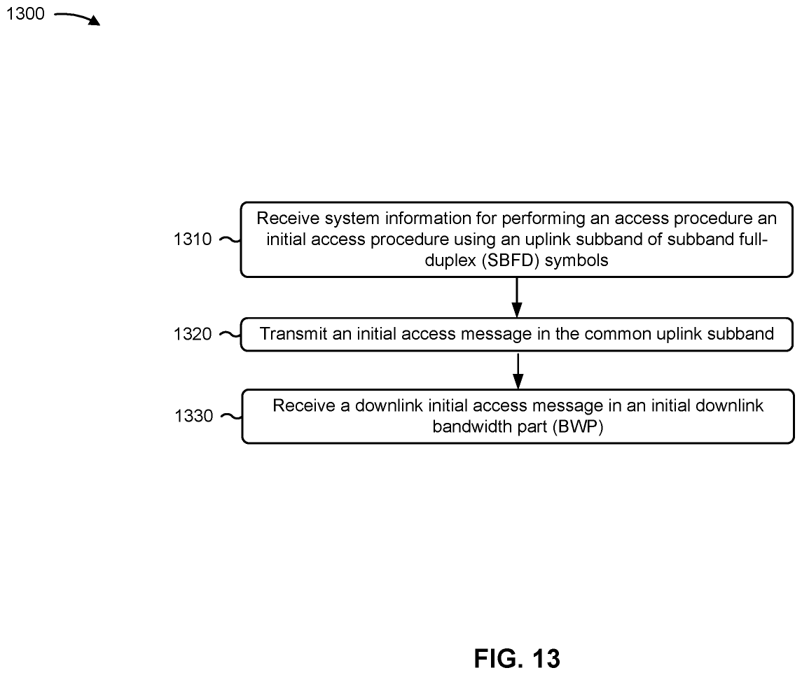

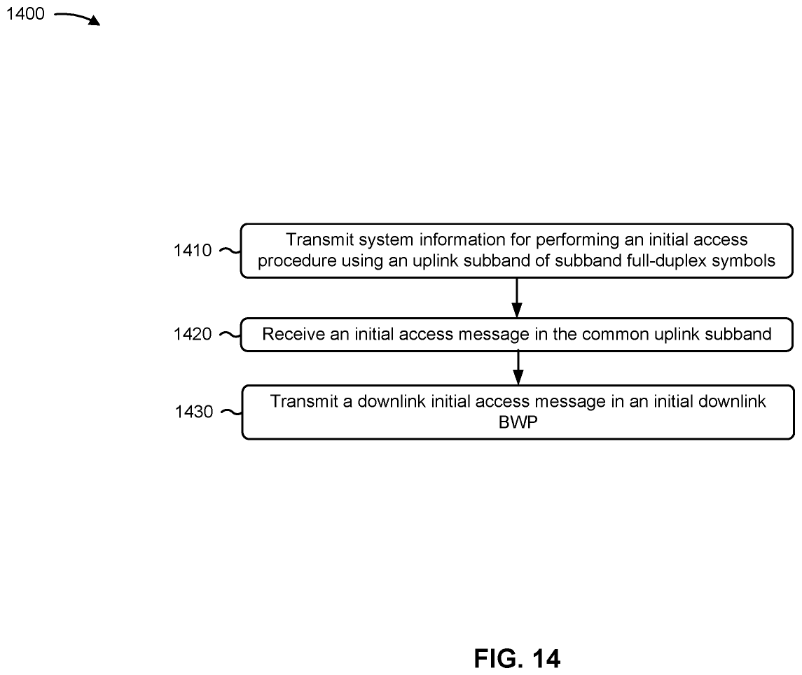

The controller/processor of a network entity (e.g., controller/processor 240 of the base station 110), the controller/processor 280 of the UE 120, or any other component(s) of FIG. 2 may perform one or more techniques associated with using an UL-SB for initial access messages, as described in more detail elsewhere herein. For example, the controller/processor 240 of the base station 110, the controller/processor 280 of the UE 120, or any other component(s) of FIG. 2 may perform or direct operations of, for example, process 1300 of FIG. 13, process 1400 of FIG. 14, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (e.g., code or program code) for wireless communication. For example, the one or more instructions, when executed (e.g., directly, or after compiling, converting, or interpreting) by one or more processors of the base station 110 or the UE 120, may cause the one or more processors, the UE 120, or the base station 110 to perform or direct operations of, for example, process 1300 of FIG. 13, process 1400 of FIG. 14, or other processes as described herein. In some examples, executing instructions may include running the instructions, converting the instructions, compiling the instructions, or interpreting the instructions, among other examples.

In some aspects, the UE 120 includes means for receiving system information for an UL-SB for initial access procedure messages in an SBFD configuration; and/or means for transmitting an initial access message in the UL-SB. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving system information for performing an initial access procedure using an uplink subband of SBFD symbols; and/or means for transmitting an initial access message in the uplink subband.

In some aspects, a network entity (e.g., base station 110) includes means for transmitting system information for an UL-SB for initial access procedure messages in a subband full-duplex configuration; and/or means for receiving an initial access message in the UL-SB. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network entity includes means for transmitting system information for performing an initial access procedure using an uplink subband of SBFD symbols; and/or means for receiving an initial access message in the uplink subband.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (e.g., within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

As indicated above, FIG. 2 is provided as an example. Other examples may differ from what is described with regard to FIG. 2.

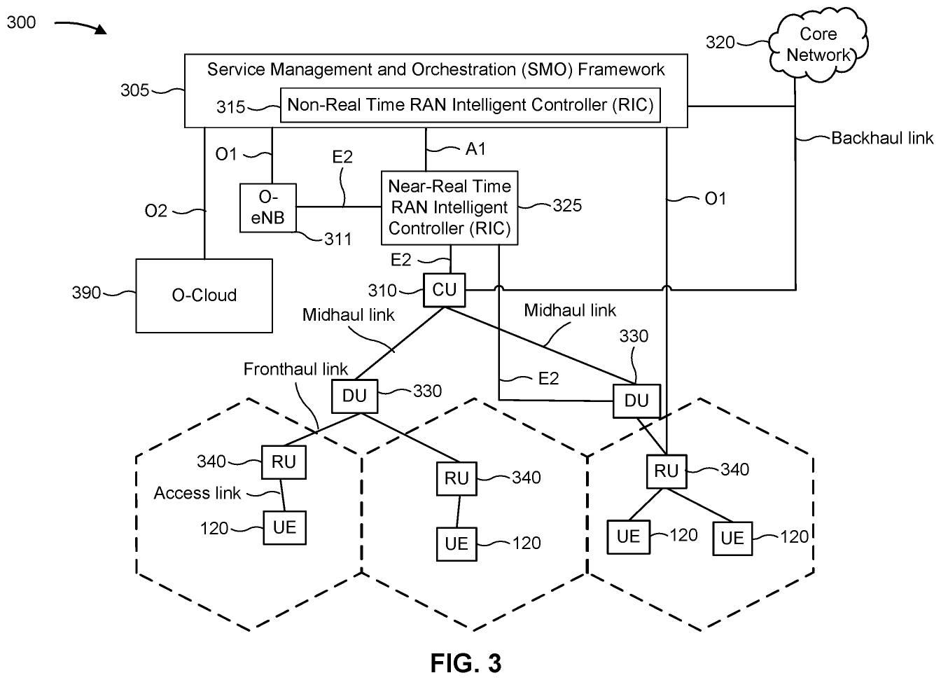

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (e.g., Central Unit-User Plane (CU-UP) functionality), control plane functionality (e.g., Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which may also be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based at least in part on a functional split (e.g., a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

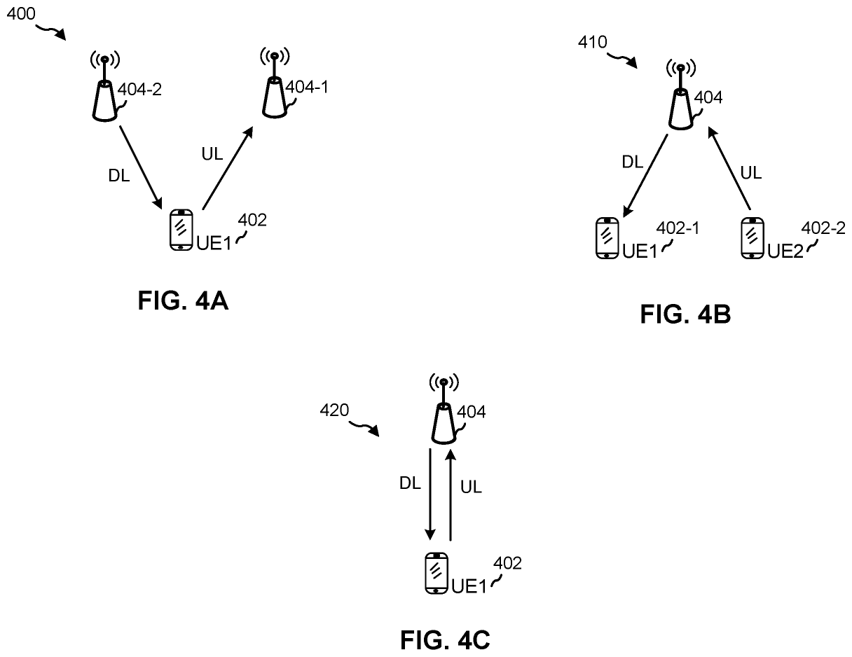

FIGS. 4A-4C are diagrams illustrating examples of full-duplex (FD) communication in accordance with the present disclosure. A first full-duplex scenario 400 depicted in FIG. 4A includes a UE1 402 and two base stations (e.g., network entities or TRPs) 404-1, 404-2, where the UE1 402 is sending uplink transmissions to base station 404-1 and is receiving downlink transmissions from base station 404-2. In the first full-duplex scenario 400 of FIG. 4A, FD is enabled for the UE1 402, but not for the base stations 404-1, 404-2. A second full-duplex scenario 410 depicted in FIG. 4B includes two UEs, shown as UE1 402-1 and UE2 402-2, and a base station 404, where the UE1 402-1 is receiving a downlink transmission from the base station 404 and the UE2 402-2 is transmitting an uplink transmission to the base station 404. In the second full-duplex scenario 410, FD is enabled for the base station 404, but not for UE1 402-1 and UE2 402-2. A third full-duplex scenario 420 is depicted in FIG. 4C that includes a UE1 402 and a base station 404, where the UE1 402 is receiving a downlink transmission from the base station 404 and the UE1 402 is transmitting an uplink transmission to the base station 404. In the third full-duplex scenario 420, FD is enabled for both the UE1 402 and the base station 404.

As indicated above, FIGS. 4A-4C provide some examples. Other examples may differ from what is described with regard to FIGS. 4A-4C.

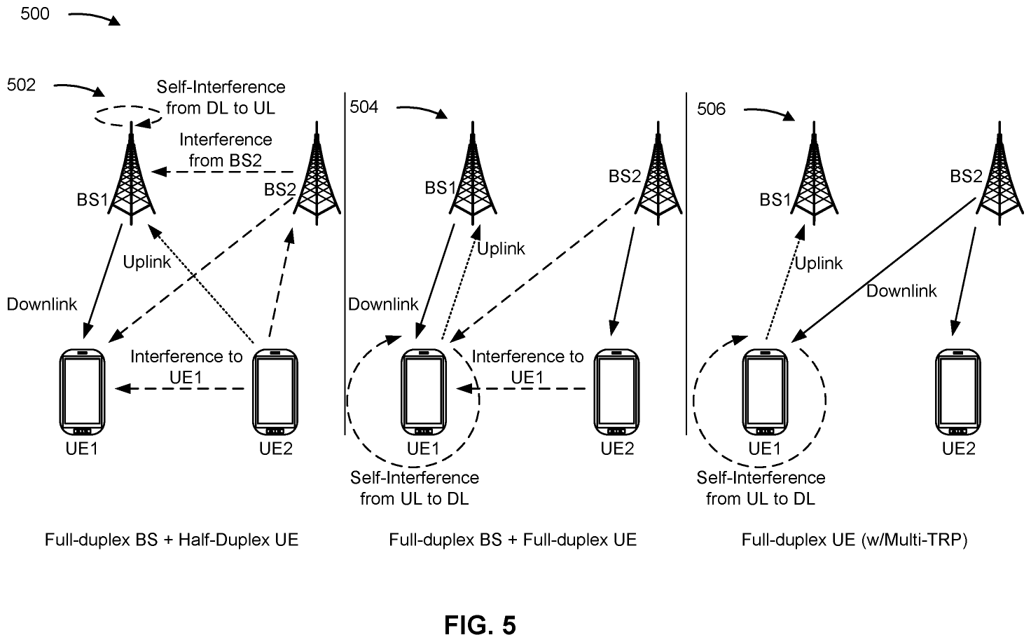

FIG. 5 is a diagram illustrating an example of full-duplex communication modes 500, in accordance with the present disclosure. In a first mode 502, a first network entity (shown as BS1) and a second network entity (shown as BS2) may be full-duplex devices (e.g., may be capable of communicating in a full-duplex manner). A first UE and a second UE may be half duplex UEs (e.g., may not be capable of communicating in a full-duplex manner). The first network entity may perform downlink transmissions to the first UE, and the first network entity may receive uplink transmissions from the second UE. The first network entity may experience self-interference (SI) from a downlink to an uplink based at least in part on the downlink transmissions to the first UE and the uplink transmissions received from the second UE. The first network entity may experience interference from the second network entity. The first UE may experience cross-link interference (CLI) from the second network entity and the second UE.

In a second mode 504, a first network entity and a second network entity may be full-duplex devices. A first UE and a second UE may be full-duplex UEs. The first network entity may perform downlink transmissions to the first UE, and the first network entity may receive uplink transmissions from the first UE. The first UE may experience SI from an uplink to a downlink based at least in part on the downlink transmissions from the first network entity and the uplink transmissions to the first network entity. The first UE may experience CLI from the second network entity and the second UE.

In a third mode 506, a first UE and a second UE may be full-duplex UEs and may communicate in a multiple TRP configuration. A first network entity may receive uplink transmissions from the first UE, and a second network entity may perform downlink transmissions to the first UE and the second UE. The first UE may experience SI from an uplink to a downlink based at least in part on the uplink transmissions to the first network entity and the downlink transmissions from the second network entity.

As indicated above, FIG. 5 is provided as an example. Other examples may differ from what is described with regard to FIG. 5.

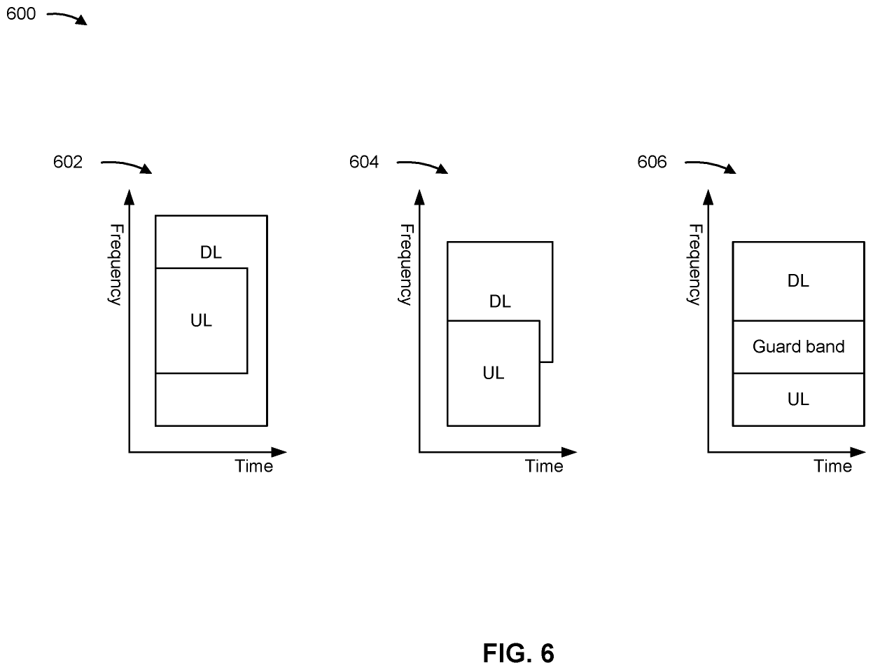

FIG. 6 is a diagram illustrating examples of full-duplex communication 600, in accordance with the present disclosure. In some cases, a wireless communication device (such as a UE or a network entity) may support full-duplex operations. Full-duplex operations may include the wireless communication device transmitting and receiving at approximately the same time.

A UE may operate in an in-band full-duplex mode. In the in-band full-duplex mode, the UE may transmit and receive on a same time and frequency resource. An uplink and a downlink may share the same time and frequency resource. For example, in a first full-duplex communication 602, a time and frequency resource for the uplink may fully overlap with a time and frequency resource for the downlink. As another example, in a second full-duplex communication 604, a time and frequency resource for the uplink may partially overlap with a time and frequency resource for the downlink.

Full-duplex operations may include SBFD mode. The SBFD mode may also be referred to as a subband frequency division duplex mode or a flexible duplex mode. SBFD communication 606 shows that the wireless communication device may transmit and receive at a same time (in the same SBFD slot), but the wireless communication device may transmit and receive on different frequency domain resources. For example, a network entity may be operating in an SBFD mode. The network entity may schedule a first UE to receive a downlink communication in an SBFD slot. The network entity may schedule a second UE to transmit an uplink communication in the same SBFD slot. However, the uplink communication may cause interference for the first UE that is receiving the downlink communication. To address this, a downlink time/frequency resource in the SBFD slot may be separated (e.g., in time or frequency) from an uplink time/frequency resource in the SBFD slot by a gap, which may function to reduce self-interference and improve latency and uplink coverage. The gap may be a frequency offset or a frequency gap (guard band) between downlink time/frequency resources and uplink time/frequency resources in the same SBFD slot.

In some cases, a slot pattern may include a combination of downlink slots, uplink slots, or SBFD slots.

As indicated above, FIG. 6 is provided as an example. Other examples may differ from what is described with regard to FIG. 6.

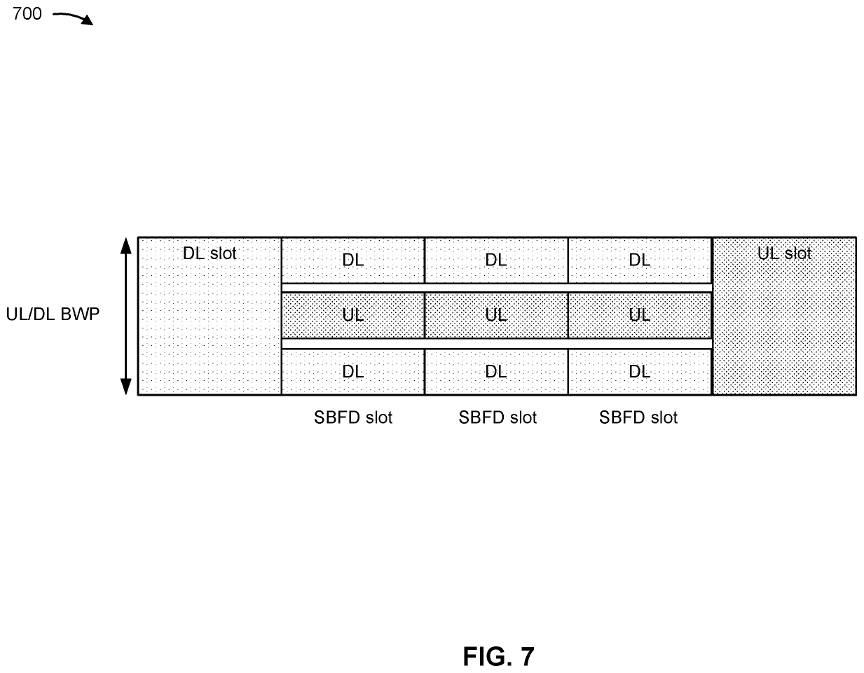

FIG. 7 is a diagram illustrating an example 700 of a slot pattern with SBFD slots, in accordance with the present disclosure.

A UE may transmit or receive communications using a configured slot pattern. The configured slot pattern may include a combination of downlink slots, uplink slots, or SBFD slots within a bandwidth part (BWP) for uplink (UL) and downlink (DL). Example 700 shows SBFD slots that may be used for operation in an RRC connected state, where the UE maintains a connection that is established with RRC signaling. The time and frequency locations of subbands for SBFD operation may not be known to UEs. In some examples, the UE may be an SBFD-aware UE, where the time and frequency locations of subbands for SBFD operation are known to the SBFD-aware UE.

As indicated above, FIG. 7 is provided as an example. Other examples may differ from what is described with regard to FIG. 7.

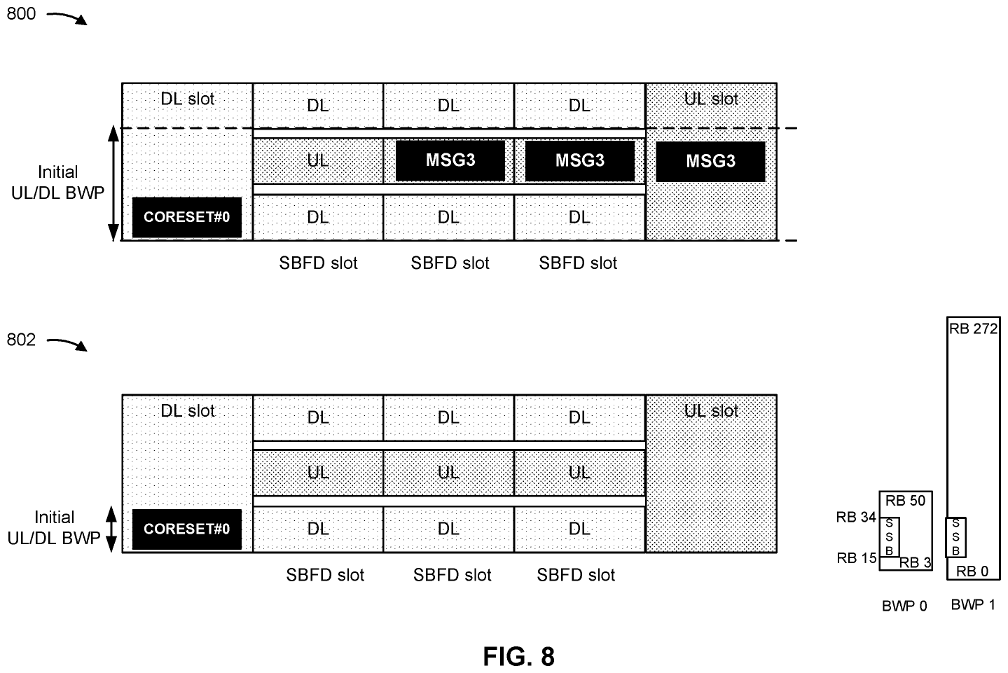

FIG. 8 is a diagram illustrating examples 800 and 802 of slot patterns for SBFD operation, in accordance with the present disclosure.

For an SBFD-aware UE in an RRC idle state, information about the UL/DL subband (SB) configuration is beneficial for multiple reasons. Within an initial access procedure, the UE may utilize an initial UL-SB to enable repetition and frequency hopping of PRACH msg1 and msg3, which enhances the uplink coverage for initial access. Another benefit is that additional RACH occasions (ROs) for RACH messages within the UL-SB reduces the collisions and enables more UEs to access the network. An additional benefit is that latency can be reduced for a random access procedure, initial access, and/or handover when Layer 1 (L1) and Layer 2 (L2) mobility is adopted.

Example 800 shows msg3 repetition in a slot pattern with SBFD slots within an initial UL/DL BWP. Before the UE reads the system information block (SIB1), the UE's initial DL BWP has the same frequency range and numerology as those of control resource set zero (CORESET #0). After reading the SIB1, the UE may follow the initial DL/UL BWP configuration in the SIB1 to carry out a random access procedure to set up an RRC connection. A network entity may configure the frequency domain location and the bandwidth of the initial DL BWP in the SIB1 such that the initial DL BWP contains the entire CORESET #0 in the frequency domain.

In order for the RRC idle UE to know the UL/DL subband configurations, the network entity is expected to broadcast the UL/DL SB time and frequency configurations (e.g., SIB1 to carry both the tdd-ul-dl common and dl-ul-sb). For time division duplex (TDD), the initial UL/DL BWP is expected to have a center-aligned frequency. However, it is not determined how the initial UL/DL BWP and an initial UL-SB are to enable the benefits of SBFD for initial access. Furthermore, the network entity may configure narrowband initial UL/DL BWP, as shown by example 802. A narrowband initial UL/DL BWP may be used where BWP 0 (initial BWP) is 48 resource blocks (RBs) and BWP 1 is a wideband of 273 RBs. The network entity may indicate to the UE the UL/DL SB configuration. However, the UE is not configured to use ROs and other physical uplink control channel (PUCCH) or physical uplink shared channel (PUSCH) communications within the initial UL-SB or the initial UL/DL BWP. Without information as to how ROs, PUCCH, and PUSCH are handled with respect to the initial UL/DL BWP, an UL/DL SB configuration, and the initial UL-SB, the UE may not utilize resources of an SBFD slot. The initial access may take longer if the UE is to wait for an UL slot to transmit an initial access message.

As indicated above, FIG. 8 is provided as an example. Other examples may differ from what is described with regard to FIG. 8.

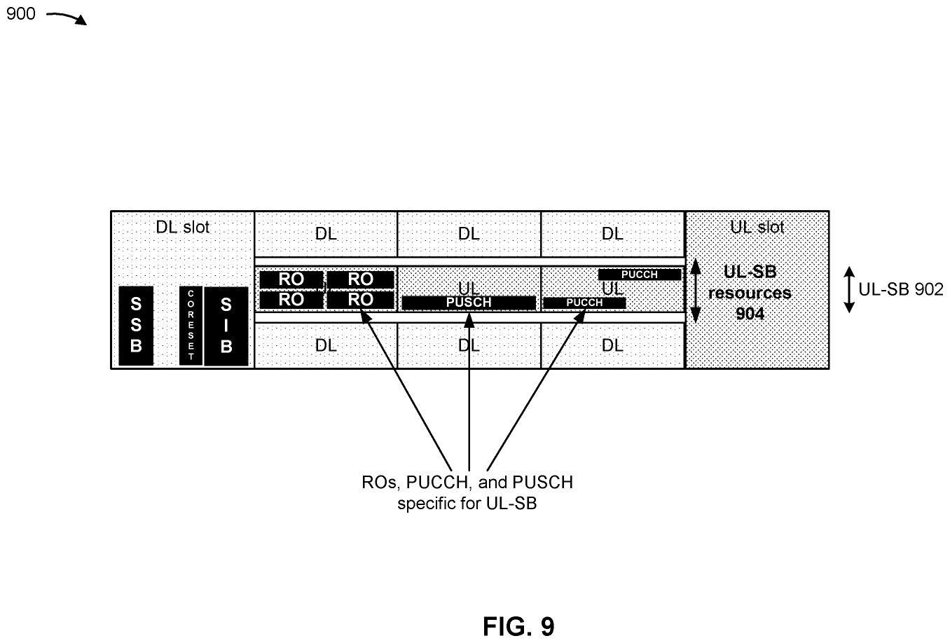

FIG. 9 is a diagram illustrating an example 900 of an UL-SB, in accordance with the present disclosure.

According to various aspects described herein, an RRC idle UE may be configured with an UL-SB 902 that can be used for initial access (e.g., RACH) messages when the UE is using an SBFD configuration (e.g., configuration specifying use of SBFD slots). An UL-SB for an SBFD configuration includes an UL-SB in SBFD slots. An SBFD slot includes symbols, or SBFD symbols. The UL-SB 902 may also be used for a PUCCH, a PUSCH, or sounding reference signals (SRSs). The network entity may use system information (e.g., SIB1) to configure the UE with the UL-SB 902. In some aspects, the UL-SB 902 may be a common UL-SB that is considered to be “common” because the UL-SB 902 may be available to multiple UEs. The UL-SB may be an initial UL-SB configured with cell-specific parameters. The UL-SB 902 may be applicable to SBFD-aware UEs, or SBFD-aware half-duplex UEs. The UL-SB 902 may be equal to, included in, or overlap with UL-SB resources 904 configured for the UE. For example, the UL-SB 902 may be equal to or a subset of frequencies or RBs configured for UL-SB resources 904.

The configuration of the UL-SB 902 may include UL-SB specific RACH, PUCCH, and/or PUSCH configurations and time and frequency locations of the UL-SB 902. The configuration may be provided in addition to an initial UL BWP common configuration (e.g., cell-specific parameters for RACH/PUCCH/PUSCH configuration of BWP 0). The UL-SB 902 for RRC idle may be equal to an UL-SB for RRC connected.

Example 900 shows multiple ROs, a PUCCH communication, and PUSCH communications that are located within the UL-SB 902 in SBFD slots. Other initial access messages may be included in the UL-SB 902, such as msg1, msg3, msgA, a msg5, a msg7, a msg9, or other initial access messages. The msg1, msg3, and msgA may be for a RACH procedure, and msg5, msg7, and msg9 may be for another initial access procedure, such as for indicating a capability or assistance information. The UE may receive an access message in the UL-SB 902. By using the UL-SB 902, an SBFD-aware UE may have information as to how to transmit initial access (e.g., RACH) messages, PUCCH communications, and PUSCH communications in SBFD operation. As a result, an RRC idle UE may reduce latency when performing initial access, because the UE does not need to wait for an uplink slot. The UE may use the UL-SB 902 in SBFD operation to reduce CLI and avoid UL/DL slot collisions, which conserves power, processing resources, and signaling resources.

As indicated above, FIG. 9 is provided as an example. Other examples may differ from what is described with regard to FIG. 9.

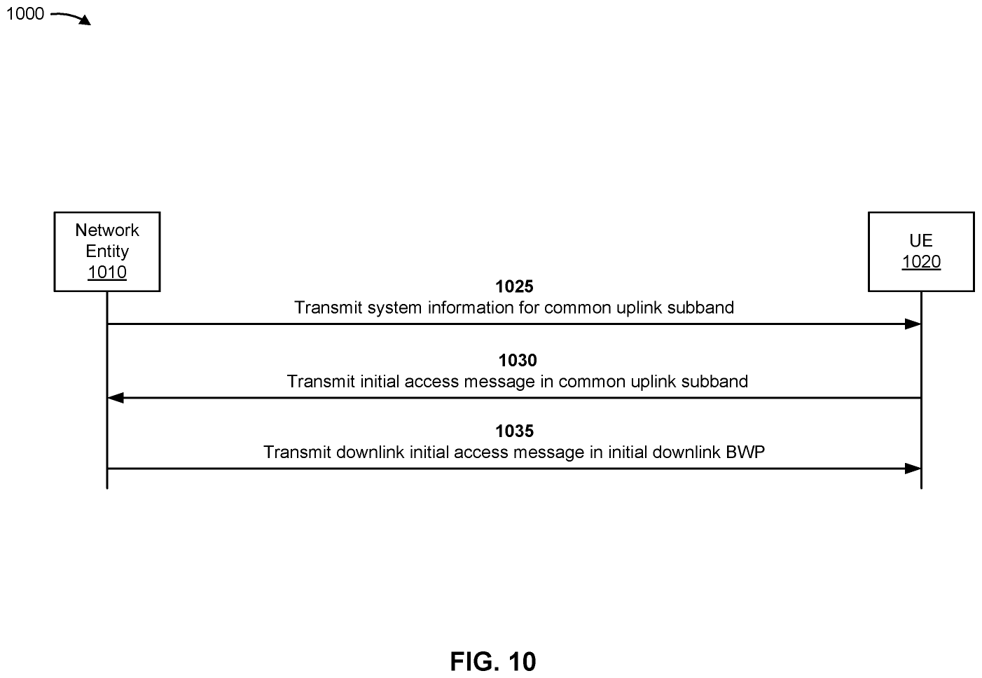

FIG. 10 is a diagram of an example 1000 associated with using an UL-SB, in accordance with the present disclosure. As shown in FIG. 10, a network entity 1010 (e.g., a base station 110) may communicate with a UE 1020 (e.g., a UE 120). In some aspects, the network entity 1010 and the UE 1020 may be part of a wireless network (e.g., the wireless network 100).

As shown by reference number 1025, the network entity 1010 may transmit system information (e.g., SIB1) for an UL-SB. The UL-SB may be for initial access procedure (e.g., RACH procedure) messages in an SBFD configuration. Initial access procedure messages in an SBFD configuration may be for performing an initial access procedure using an UL-SB in SBFD slots (SBFD symbols). The UL-SB may be for a PUCCH and/or a PUSCH. The UL-SB may be for SRSs. The system information may indicate a frequency and/or RBs for the UL-SB. The system information may indicate a time location for the UL-SB. The UE 1020 may be in an RRC idle state.

As shown by reference number 1030, the UE 1020 may transmit an initial access message in the UL-SB. The initial access message may be a RACH msg1, a RACH msg3, a RACH msgA, a msg5, a msg7, or a msg9. As shown by reference number 1035, the network entity 1010 may transmit a DL initial access message in an initial DL BWP. The UE 1020 may enter an RRC connected state. The UE 1020 may reduce latency for initial access by using the UL-SB rather than waiting for a later UL slot.

As indicated above, FIG. 10 is provided as an example. Other examples may differ from what is described with regard to FIG. 10.

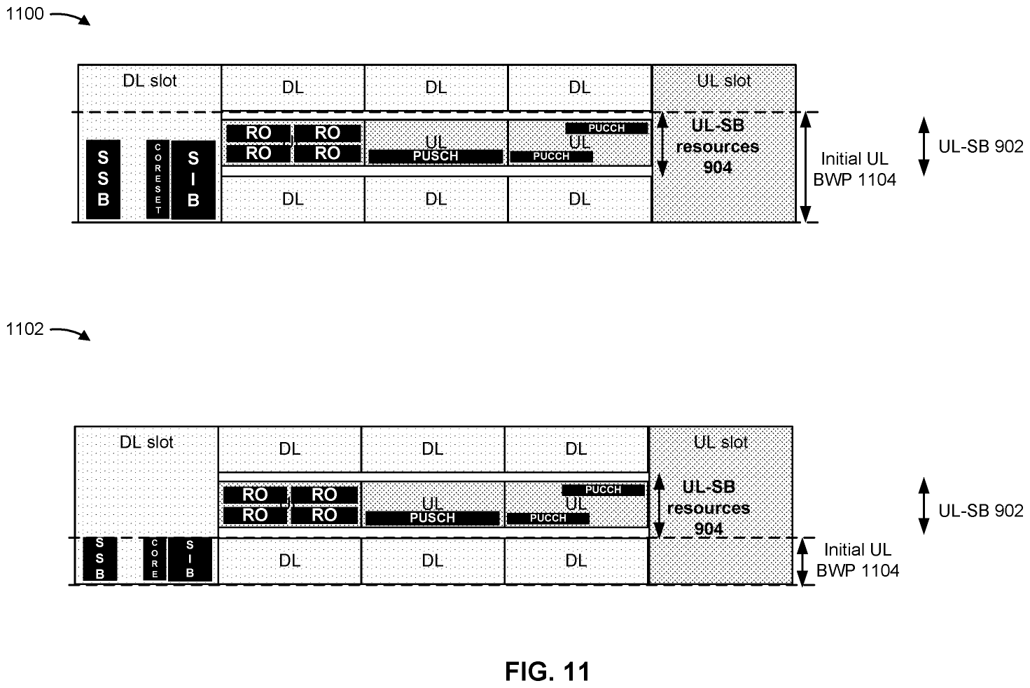

FIG. 11 is a diagram illustrating examples 1100 and 1102 of uplink frequency resources, in accordance with the present disclosure.

In some aspects, the UL frequency resources of an SBFD-aware UE may be based at least in part on the BWP resources. The UL frequency resources may be based at least in part on the initial UL BWP 1104. Because the initial UL BWP 1104 and the UL-SB resources 904 are configured differently, there could be multiple scenarios. In a first scenario shown by example 1100, the initial UL-SB frequency resources may be fully contained within the initial UL BWP 1104. The network entity 1010 may configure the initial UL BWP 1104 to include the UL-SB resources 904. In some aspects, the UL frequency resources for the UL-SB 902 may be within the UL frequency resources of the first scenario.

In a second scenario shown by example 1102, the UL frequency resources of the SBFD-aware UE may not be fully contained (e.g., partially overlap, separate) within the initial UL BWP 1104. The UL frequency resources may be within a union of the UL-SB resources 904 and the initial uplink BWP 1104. There may be no condition on UL-SB resources 904 and initial UL BWP 1104 configurations. The UL frequency resources for the UL-SB 902 may be within the UL frequency resources of the second scenario. In some aspects, the UL frequency resources of the SBFD-aware UE may include a union of the frequency resources of the UL-SB 902 and the frequency resources of the initial UL BWP 1104.

In some aspects, when the initial UL BWP 1104 is not configured while the UL-SB resources 904 are configured, the initial UL BWP 1104 may be the combination of the UL-SB resources 904 and a CORESET #0 bandwidth or a combination of the frequency resources of the UL-SB 902 and the CORESET #0 bandwidth. The UL frequency resources of the UL-SB 902 may be within a union of UL-SB resources 904 and a CORESET #0 bandwidth. Alternatively, in an error case, if the network entity 1010 indicates UL-SB resources 904 (or the UL-SB 902), the network entity 1010 may also indicate the UL BWP.

As indicated above, FIG. 11 provides some examples. Other examples may differ from what is described with regard to FIG. 11.

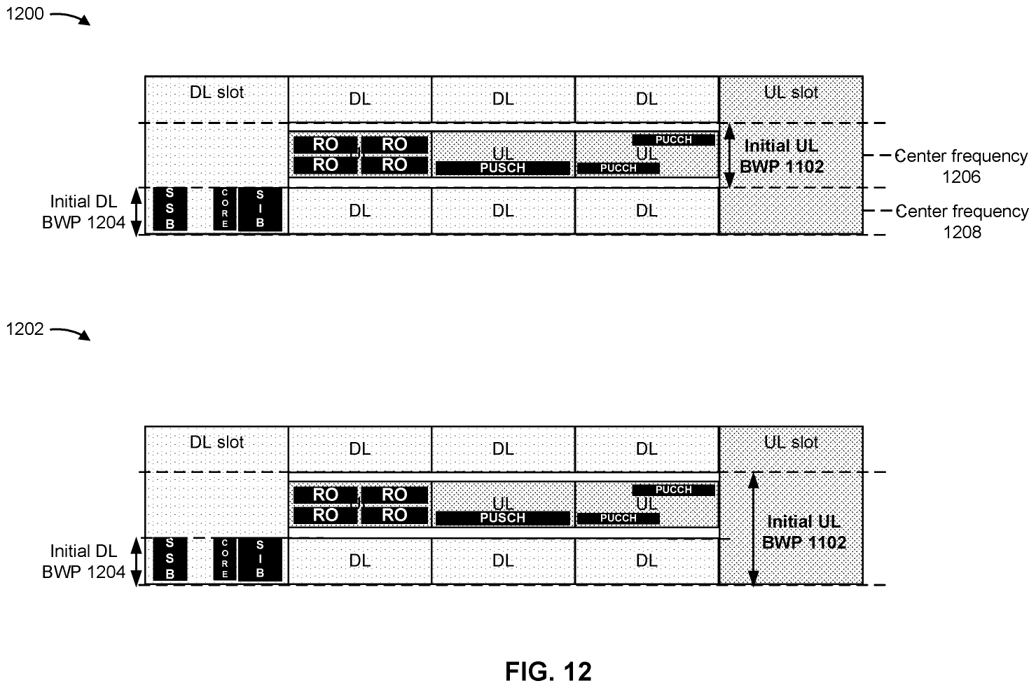

FIG. 12 is a diagram illustrating examples 1200 and 1202 of an initial UL BWP, in accordance with the present disclosure.

Example 1200 shows an initial DL BWP 1204 that is not within the initial UL BWP 1102. Example 1202 shows the initial DL BWP 1204 within the initial UL BWP 1102. The initial UL BWP 1102 and the initial DL BWP 1204 may have the same center frequency. Then, instead of introducing UL-SB resources 904, the center frequency alignment may be relaxed for the initial UL BWP 1102 and/or initial DL BWP 1204 such that a narrowband UL BWP coinciding with the UL-SB resources 904 can be configured for the UE. Accordingly, in some aspects for an SBFD-aware UE, the initial UL BWP 1102 may be configured with a center frequency 1206 that is not aligned with a center frequency 1208 of the initial DL BWP 1204. This may include the use of an information element (IE) that allows for an indication of non-aligned center frequencies. In some aspects, the network entity may configure an initial UL-SB 904 such that the initial UL-SB 904 includes the UL-SB 902 in SBFD operation. The network entity may configure the UE to transmit RACH messages in ROs, a PUCCH communication, a PUSCH communication, and/or an SRS in the UL-SB 902 within the initial UL BWP 1102.

As indicated above, FIG. 12 provides some examples. Other examples may differ from what is described with regard to FIG. 12.

FIG. 13 is a diagram illustrating an example process 1300 performed, for example, by a UE, in accordance with the present disclosure. Example process 1300 is an example where the UE (e.g., UE 120, UE 1020) performs operations associated with using an UL-SB for random access message, among other communications.

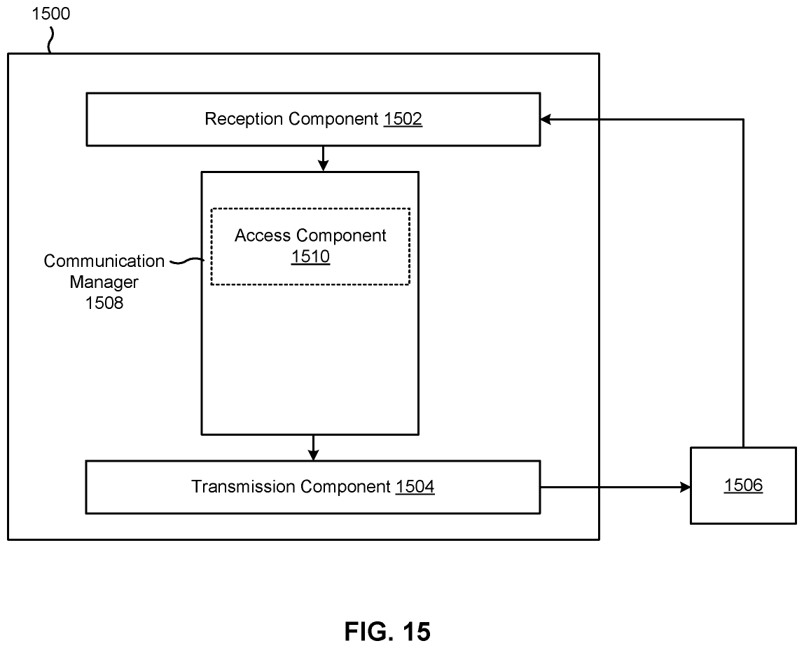

As shown in FIG. 13, in some aspects, process 1300 may include receiving system information for performing an initial access procedure using an UL-SB of SBFD symbols (block 1310). For example, the UE (e.g., using reception component 1502 and/or communication manager 1506, depicted in FIG. 15) may receive system information for performing an initial access procedure using an UL-SB of SBFD symbols, as described above.

In some aspects, process 1300 may include receiving system information for an UL-SB for initial access procedure (e.g., RACH procedure) messages in an SBFD configuration. For example, the UE (e.g., using communication manager 1508 and/or reception component 1502 depicted in FIG. 15) may receive system information for an UL-SB for initial access procedure messages in an SBFD configuration, as described above.

In some aspects, process 1300 may include transmitting an initial access message in the UL-SB. For example, the UE (e.g., using communication manager 1508 and/or transmission component 1504 depicted in FIG. 15) may transmit an initial access message in the UL-SB, as described above.

As further shown in FIG. 13, in some aspects, process 1300 may include receiving a DL initial access message in an initial DL BWP (block 1330). For example, the UE (e.g., using communication manager 1508 and/or reception component 1502 depicted in FIG. 15) may receive a DL initial access message in an initial DL BWP, as described above. In some aspects, the system information provides a physical uplink channel configuration that is specific to uplink subbands. The physical uplink channel configuration may include a PRACH configuration, a PUCCH configuration, or a PUSCH configuration.

Process 1300 may include additional aspects, such as any single aspect or any combination of aspects described below and/or in connection with one or more other processes described elsewhere herein.

In a first aspect, the UL-SB is for one or more of a PUCCH, a PUSCH, or an SRS.

In a second aspect, alone or in combination with the first aspect, the system information indicates a frequency band, RBs, and/or a time location for the UL-SB.

In a third aspect, alone or in combination with one or more of the first and second aspects, the initial access message is a RACH msg1, a RACH msg3, a RACH msgA, a msg5, a msg7, a msg9, or other initial access messages.

In a fourth aspect, alone or in combination with one or more of the first through third aspects, the UE is configured to be SBFD-aware (e.g., with information about an SBFD configuration) or an SBFD-aware half-duplex UE that is configured to use SBs in a half-duplex mode.

In a fifth aspect, alone or in combination with one or more of the first through fourth aspects, uplink frequency resources of the UL-SB are based at least in part on an initial uplink BWP.

In a sixth aspect, alone or in combination with one or more of the first through fifth aspects, the uplink frequency resources of the UL-SB are within the initial uplink BWP.

In a seventh aspect, alone or in combination with one or more of the first through sixth aspects, the uplink frequency resources of the UL-SB are within a union of UL-SB resources and the initial uplink BWP.

In an eighth aspect, alone or in combination with one or more of the first through seventh aspects, a center frequency of the initial uplink BWP is not center-aligned with a center frequency of an initial downlink BWP.

In a ninth aspect, alone or in combination with one or more of the first through eighth aspects, uplink frequency resources of the UL-SB are a subset of UL-SB resources.

In a tenth aspect, alone or in combination with one or more of the first through ninth aspects, uplink frequency resources of the UL-SB are within a union of UL-SB resources and a CORESET #0 bandwidth.

In an eleventh aspect, alone in combination with one or more of the first through tenth aspects, the uplink subband includes one or more of a common uplink subband or an initial uplink subband configured with cell-specific parameters.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network entity, in accordance with the present disclosure. Example process 1400 is an example where the network entity (e.g., base station 110, network entity 1010) performs operations associated with indicating an UL-SB.

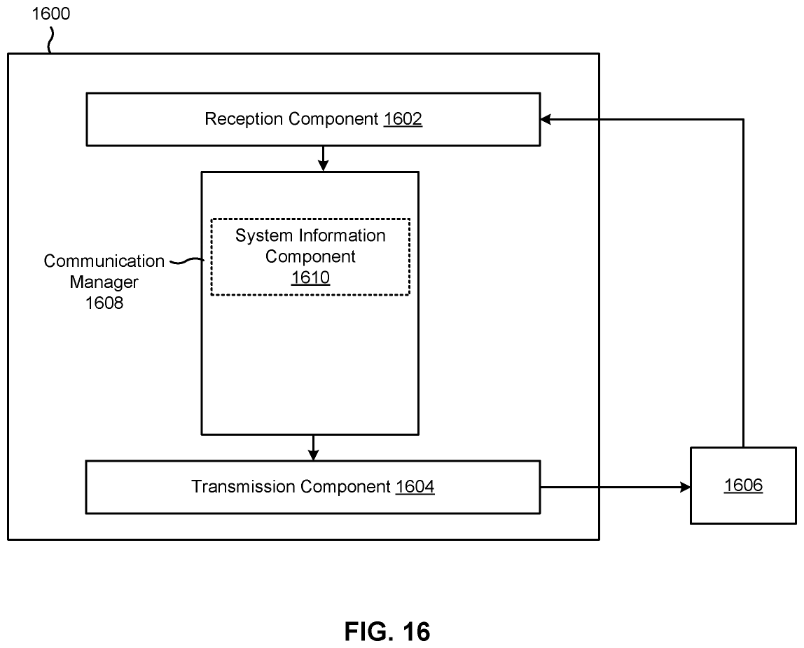

As shown in FIG. 14, in some aspects, process 1400 may include transmitting system information for performing an initial access procedure using an UL-SB of SBFD symbols (block 1410). For example, the network entity (e.g., using transmission component 1604 and/or communication manager 1608, depicted in FIG. 16, depicted in FIG. 16) may transmit system information for performing an initial access procedure using an UL-SB of SBFD symbols, as described above.

In some aspects, process 1400 may include transmitting system information for an UL-SB for initial access procedure (e.g., RACH procedure) messages in an SBFD configuration. For example, the network entity (e.g., using communication manager 1608 and/or transmission component 1604 depicted in FIG. 16) may transmit system information for an UL-SB for initial access procedure messages in an SBFD configuration, as described above.

In some aspects, process 1400 may include receiving an initial access message in the UL-SB. For example, the network entity (e.g., using communication manager 1608 and/or reception component 1602 depicted in FIG. 16) may receive an initial access message in the UL-SB, as described above.

As further shown in FIG. 14, in some aspects, process 1400 may include transmitting a DL initial access message in an initial DL BWP (block 1430). For example, the UE (e.g., using communication manager 1608 and/or transmission component 1604 depicted in FIG. 16) may receive a DL initial access message in an initial DL BWP, as described above. In some aspects, the system information provides a physical uplink channel configuration that is specific to uplink subbands. The physical uplink channel configuration may include a PRACH configuration, a PUCCH configuration, or a PUSCH configuration.

Process 1400 may include additional aspects, such as any single aspect or any combination of aspects described below and/or in connection with one or more other processes described elsewhere herein.

In a first aspect, the UL-SB is for a PUCCH, a PUSCH, or an SRS.

In a second aspect, alone or in combination with the first aspect, the system information indicates a frequency band, RBs, or a time location for the UL-SB.

In a third aspect, alone or in combination with one or more of the first and second aspects, the initial access message is a RACH msg1, a RACH msg3, a RACH msgA, a msg5, a msg7, a msg9, or other initial access messages.

In a fourth aspect, alone or in combination with one or more of the first through third aspects, uplink frequency resources of the UL-SB are based at least in part on an initial uplink BWP.

In a fifth aspect, alone or in combination with one or more of the first through fourth aspects, the uplink frequency resources of the UL-SB are within the initial uplink BWP.

In a sixth aspect, alone or in combination with one or more of the first through fifth aspects, the uplink frequency resources of the UL-SB are within a union of UL-SB resources and the initial uplink BWP.

In a seventh aspect, alone or in combination with one or more of the first through sixth aspects, a center frequency of the initial uplink BWP is not center-aligned with a center frequency of an initial downlink BWP.

In an eighth aspect, alone or in combination with one or more of the first through seventh aspects, uplink frequency resources of the UL-SB are a subset of UL-SB resources.

In a ninth aspect, alone or in combination with one or more of the first through eighth aspects, uplink frequency resources of the UL-SB are within a union of UL-SB resources and a CORESET #0 bandwidth.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE (e.g., UE 120, UE 1020), or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 1508. The communication manager 1508 may control and/or otherwise manage one or more operations of the reception component 1502 and/or the transmission component 1504. In some aspects, the communication manager 1508 may include one or more antennas, a modem, a controller/processor, a memory, or a combination thereof, of the UE described in connection with FIG. 2. The communication manager 1508 may be, or be similar to, the communication manager 140 depicted in FIGS. 1 and 2. For example, in some aspects, the communication manager 1508 may be configured to perform one or more of the functions described as being performed by the communication manager 140. In some aspects, the communication manager 1508 may include the reception component 1502 and/or the transmission component 1504. The communication manager 1508 may include an access component 1510, among other examples.

In some aspects, the apparatus 1500 may be configured to perform one or more operations described herein in connection with FIGS. 1-12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

In some aspects, the reception component 1502 may receive system information for performing an initial access procedure (e.g., RACH procedure) using an UL-SB of SBFD symbols. The transmission component 1504 may transmit an initial access message in the UL-SB.

In some aspects, the reception component 1502 may receive system information for an UL-SB for initial access procedure messages in an SBFD configuration. The access component 1510 may generate the initial access procedures (e.g., RACH procedures) based at least in part on a UE capability, traffic conditions, and/or channel conditions. The transmission component 1504 may transmit an initial access message in the UL-SB.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network entity (e.g., base station 110, network entity 1010), or a network entity may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 1608. The communication manager 1608 may control and/or otherwise manage one or more operations of the reception component 1602 and/or the transmission component 1604. In some aspects, the communication manager 1608 may include one or more antennas, a modem, a controller/processor, a memory, or a combination thereof, of the network entity described in connection with FIG. 2. The communication manager 1608 may be, or be similar to, the communication manager 150 depicted in FIGS. 1 and 2. For example, in some aspects, the communication manager 1608 may be configured to perform one or more of the functions described as being performed by the communication manager 150. In some aspects, the communication manager 1608 may include the reception component 1602 and/or the transmission component 1604. The communication manager 1608 may include a system information component 1610, among other examples.

In some aspects, the apparatus 1600 may be configured to perform one or more operations described herein in connection with FIGS. 1-12. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network entity described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network entity described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network entity described in connection with FIG. 2. In some aspects, the transmission component 1604 may be co-located with the reception component 1602 in a transceiver.

In some aspects, the transmission component 1604 may transmit system information for performing an initial access procedure (e.g., RACH procedure) using an UL-SB of SBFD symbols. The reception component 1602 may receive an initial access message in the UL-SB.

In some aspects, the transmission component 1604 may transmit system information for an UL-SB for initial access procedure messages in an SBFD configuration. The system information component 1610 may generate the system information based at least in part on a UE capability, traffic conditions, and/or channel conditions. The reception component 1602 may receive an initial access message in the UL-SB.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:
Aspect 1: A method of wireless communication performed by a user equipment (UE), comprising: receiving system information for an uplink subband for initial access procedure messages in a subband full-duplex (SBFD) configuration; and transmitting an initial access message in the uplink subband.
Aspect 1 may alternatively include: A method of wireless communication performed by a user equipment (UE), comprising: receiving system information for performing an initial access procedure using an uplink subband of subband full-duplex (SBFD) symbols; and transmitting an initial access message in the uplink subband.
Aspect 2: The method of Aspect 1, wherein the system information provides a physical uplink channel configuration that is specific to uplink subbands.
Aspect 3: The method of Aspect 1 or 2, wherein the physical uplink channel configuration includes a physical random access channel configuration, a physical uplink control channel configuration, or a physical uplink shared channel configuration.
Aspect 4: The method of any of Aspects 1-3, wherein the uplink subband is for one or more of a physical uplink shared channel, a physical uplink control channel, or a sounding reference signal.
Aspect 5: The method of any of Aspects 1-4, wherein the system information indicates one or more of a frequency band, resource blocks, or a time location for the uplink subband.
Aspect 6: The method of any of Aspects 1-5, wherein the initial access message is a random access channel (RACH) msg1, a RACH msg3, a RACH msgA, a msg5, a msg7, or a msg9.
Aspect 7: The method of any of Aspects 1-6, wherein the UE is configured to be an SBFD-aware half-duplex UE.
Aspect 8: The method of any of Aspects 1-7, wherein uplink frequency resources of the uplink subband are based at least in part on an initial uplink bandwidth part (BWP).
Aspect 9: The method of Aspect 8, wherein the uplink frequency resources of the uplink subband are within the initial uplink BWP.
Aspect 10: The method of Aspect 8, wherein the uplink frequency resources of the uplink subband are within a union of uplink subband resources and the initial uplink BWP.
Aspect 11: The method of any of Aspects 8-10, wherein a center frequency of the initial uplink BWP is not center-aligned with a center frequency of an initial downlink BWP.
Aspect 12: The method of any of Aspects 1-11, wherein uplink frequency resources of the uplink subband are a subset of uplink subband resources.
Aspect 13: The method of any of Aspects 1-12, wherein uplink frequency resources of the uplink subband are within a union of uplink subband resources and a control resource set #0 bandwidth.
Aspect 14: The method of any of Aspects 1-13, wherein the uplink subband includes one or more of a common uplink subband or an initial uplink subband configured with cell-specific parameters.
Aspect 15: A method of wireless communication performed by a network entity, comprising: transmitting system information for an uplink subband for initial access procedure messages in a subband full-duplex configuration; and receiving an initial access message in the uplink subband.
Aspect 15 may alternatively be: A method of wireless communication performed by a network entity, comprising: transmitting system information for performing an initial access procedure using an uplink subband of subband full-duplex symbols; and receiving an initial access message in the uplink subband.
Aspect 16: The method of Aspect 15, wherein the system information provides a physical uplink channel configuration that is specific to uplink subbands.
Aspect 17: The method of Aspect 15 or 16, wherein the physical uplink channel configuration includes a physical random access channel configuration, a physical uplink control channel configuration, or a physical uplink shared channel configuration.
Aspect 18: The method of any of Aspects 15-17, wherein the uplink subband is for one or more of a physical uplink shared channel, a physical uplink control channel, or a sounding reference signal.
Aspect 19: The method of any of Aspects 15-18, wherein the system information indicates a frequency band, resource blocks, or a time location for the uplink subband.
Aspect 20: The method of any of Aspects 15-19, wherein the initial access message is a random access channel (RACH) msg1, a RACH msg3, a RACH msgA, a msg5, a msg7, or a msg9.
Aspect 21: The method of any of Aspects 15-20, wherein uplink frequency resources of the uplink subband are based at least in part on an initial uplink bandwidth part (BWP).
Aspect 22: The method of Aspect 21, wherein the uplink frequency resources of the uplink subband are within the initial uplink BWP.
Aspect 23: The method of Aspect 22, wherein the uplink frequency resources of the uplink subband are within a union of uplink subband resources and the initial uplink BWP.
Aspect 24: The method of Aspect 22 or 23, wherein a center frequency of the initial uplink BWP is not center-aligned with a center frequency of an initial downlink BWP.
Aspect 25: The method of any of Aspects 15-24, wherein uplink frequency resources of the uplink subband are a subset of uplink subband resources.
Aspect 26: The method of any of Aspects 15-25, wherein uplink frequency resources of the uplink subband are within a union of uplink subband resources and a control resource set #0 bandwidth.
Aspect 27: An apparatus for wireless communication at a device, comprising a processor; memory coupled with the processor; and instructions stored in the memory and executable by the processor to cause the apparatus to perform the method of one or more of Aspects 1-26.
Aspect 28: A device for wireless communication, comprising a memory and one or more processors coupled to the memory, the one or more processors configured to perform the method of one or more of Aspects 1-26.
Aspect 29: An apparatus for wireless communication, comprising at least one means for performing the method of one or more of Aspects 1-26.
Aspect 30: A non-transitory computer-readable medium storing code for wireless communication, the code comprising instructions executable by a processor to perform the method of one or more of Aspects 1-26.
Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors coupled to the one or more memories, the one or more processors individually or collectively configured to cause the UE to:
receive system information for performing an initial access procedure using an uplink subband of subband full-duplex (SBFD) symbols; and
transmit an initial access message in the uplink subband.

2. The UE of claim 1, wherein the system information provides a physical uplink channel configuration that is specific to uplink subbands.

3. The UE of claim 2, wherein the physical uplink channel configuration includes a physical random access channel configuration, a physical uplink control channel configuration, or a physical uplink shared channel configuration.

4. The UE of claim 1, wherein the uplink subband is for one or more of a physical uplink shared channel, a physical uplink control channel, or a sounding reference signal.

5. The UE of claim 1, wherein the system information indicates one or more of a frequency band, resource blocks, or a time location for the uplink subband.

6. The UE of claim 1, wherein the initial access message is a random access channel (RACH) msg1, a RACH msg3, a RACH msgA, a msg5, a msg7, or a msg9.

7. The UE of claim 1, wherein the UE is configured to be an SBFD-aware half-duplex UE.

8. The UE of claim 1, wherein uplink frequency resources of the uplink subband are based at least in part on an initial uplink bandwidth part (BWP).

9. The UE of claim 8, wherein the uplink frequency resources of the uplink subband are within the initial uplink BWP.

10. The UE of claim 8, wherein the uplink frequency resources of the uplink subband are within a union of uplink subband resources and the initial uplink BWP.

11. The UE of claim 8, wherein a center frequency of the initial uplink BWP is not center-aligned with a center frequency of an initial downlink BWP.

12. The UE of claim 1, wherein uplink frequency resources of the uplink subband are a subset of uplink subband resources.

13. The UE of claim 1, wherein uplink frequency resources of the uplink subband are within a union of uplink subband resources and a control resource set #0 bandwidth.

14. The UE of claim 1, wherein the uplink subband includes one or more of a common uplink subband or an initial uplink subband configured with cell-specific parameters.

15. A network entity for wireless communication, comprising:
one or more memories; and
one or more processors coupled to the one or more memories, the one or more processors individually or collectively configured to cause the network entity to:
transmit system information for performing an initial access procedure using an uplink subband of subband full-duplex symbols; and
receive an initial access message in the uplink subband.

16. The network entity of claim 15, wherein the system information provides a physical uplink channel configuration that is specific to uplink subbands.

17. The network entity of claim 16, wherein the physical uplink channel configuration includes a physical random access channel configuration, a physical uplink control channel configuration, or a physical uplink shared channel configuration.

18. The network entity of claim 15, wherein the uplink subband is for one or more of a physical uplink shared channel, a physical uplink control channel, or a sounding reference signal.

19. The network entity of claim 15, wherein the system information indicates one or more of a frequency band, resource blocks, or a time location for the uplink subband.

20. The network entity of claim 15, wherein the initial access message is a random access channel (RACH) msg1, a RACH msg3, a RACH msgA, a msg5, a msg7, or a msg9.

21. The network entity of claim 15, wherein uplink frequency resources of the uplink subband are based at least in part on an initial uplink bandwidth part (BWP).

22. The network entity of claim 21, wherein the uplink frequency resources of the uplink subband are within the initial uplink BWP.

23. The network entity of claim 21, wherein the uplink frequency resources of the uplink subband are within a union of uplink subband resources and the initial uplink BWP.

24. The network entity of claim 21, wherein a center frequency of the initial uplink BWP is not center-aligned with a center frequency of an initial downlink BWP.

25. The network entity of claim 15, wherein uplink frequency resources of the uplink subband are a subset of uplink subband resources.

26. The network entity of claim 15, wherein uplink frequency resources of the uplink subband are within a union of uplink subband resources and a control resource set #0 bandwidth.

27. A method of wireless communication performed by a user equipment (UE), comprising:
receiving system information for performing an initial access procedure using an uplink subband of subband full-duplex symbols; and
transmitting an initial access message in the uplink subband.

28. The method of claim 27, wherein the system information provides a physical uplink channel configuration that is specific to uplink subbands, and wherein the physical uplink channel configuration includes a physical random access channel configuration, a physical uplink control channel configuration, or a physical uplink shared channel configuration.

29. The method of claim 27, wherein the initial access message is a random access channel (RACH) msg1, a RACH msg3, a RACH msgA, a msg5, a msg7, or a msg9.

30. A method of wireless communication performed by a network entity, comprising:
transmitting system information for performing an initial access procedure using an uplink subband of subband full-duplex symbols; and
receiving an initial access message in the uplink subband.
